(19) United States
(12) Patent Application Publication
(10) Pub. No.: US 2011/0134453 A1
(43) Pub. Date: Jun. 9, 2011

(54) Multifunction printer and recording medium

(75) Inventor: Masahiro Sakiyama, Osaka (JP)

(73) Assignee: Sharp Kabushiki Kaisha, Osaka (JP)

(21) Appl. No.: 12/928,118

(22) Filed: Dec. 2, 2010

(30) Foreign Application Priority Data
Dec. 9, 2009 (JP) JP279777/2009

(51) Int. Cl. G06F 3/12

(52) U.S. Cl. 358/1.13

(57) ABSTRACT

In a multifunction printer, a web browser section displays in an operation section an operation window indicated by window data obtained from a web server section and notifies the web server section of an application execution instruction entered into the operation window. Then, as soon as the web server section has received the application execution instruction, the content section executes an application corresponding to the application execution instruction and, in accordance with the application, sends a device control section a control command to control at least one of a plurality of functions. Then, the device control section performs control based on the control command as converted by a function disclosure section. This makes it possible to easily add a function regardless of model.

This Nonprovisional application claims priority under 35 U.S.C. §119(a) on Patent Application No. 2009-279777 filed in Japan on Dec. 9, 2009, the entire contents of which are hereby incorporated by reference.

### TECHNICAL FIELD

The present invention relates to a multifunction printer to which a function can be added.

### BACKGROUND ART

Conventionally, there has been known a multifunction printer having a plurality of functions such as a copy function, a scan function, a print function, and a FAX sending and receiving function in combination. However, in the case of an office environment where there are unique operations, specific routine tasks, etc. that are to be performed in that environment, the standard functions of a multifunction printer are not sufficient to smoothly perform those operations. Therefore, there has been proposed a technique for mounting a multifunction printer with a platform to which a function can be added and adding a custom application suited to the environment in which the multifunction printer is installed.

An example of a technique for adding a function to a multifunction printer is a method for adding into a multifunction printer a program (Native Function) that operates on the multifunction printer. Other known examples include a method for, by ensuring cooperation between a multifunction printer and a custom application network-connected thereto, displaying on an operation panel of the multifunction printer a screen window provided by the custom application and executing a process in the multifunction printer through a function disclosed to the custom application. For example, Patent Literature 1 teaches that a browser displays an operation window indicated by HTML data obtained from a custom application and an image is processed in accordance with a specific format entered into the operation window.

### CITATION LIST

### Patent Literature 1

Japanese Patent Application Publication, Tokukai, No. 2005-149320 (Publication Date: Jun. 9, 2005)

### SUMMARY OF INVENTION

### Technical Problem

However, in the case of mere addition of a program into a multifunction printer, mounting for creating the program is complex. Further, because it is necessary to change the content of a program according to the model of multifunction printer, it is difficult to apply the same program to different models of multifunction printer.

Further, in such a case of cooperation between an external custom application and a multifunction printer as described in Patent Literature 1, a standard browser alone can only fulfill a limited number of functions. Therefore, in Patent Literature 1, the web browser is subjected to a unique extension specialized for the multifunction printer, in order that an icon, etc. unique to the multifunction printer is displayed. For this reason, in the case of use of a general-purpose web browser, such a unique extension must be applied every time the version of the web browser is upgraded or a glitch, etc. with the web browser is fixed. This causes a great reduction in efficiency of maintenance.

Furthermore, in cases where the need arises for customizing an operation window containing an icon, etc. that is displayed as a result of such a unique extension as described above, it is necessary to remediate a program containing the web browser or concomitantly use an interface different from the web browser for each multifunction printer. This requires a very great deal of effort and time.

Furthermore, depending on the environment in which a multifunction printer is installed, there is a case where it is difficult to introduce a server on which a custom application operates. Under such circumstances, it has been difficult to easily expand the functions of a multifunction printer.

Alternatively, it is possible to send a control command from an external custom application to a multifunction printer to control the various functions (a scan function, a print function, etc.) of the multifunction printer, instead of uniquely expanding a web browser of the multifunction printer. In this case, however, the control command is blocked if there is a firewall between the multifunction printer and the external custom application.

The present invention has been made in view of the foregoing problems, and it is an object of the present invention to provide a multifunction printer to which a function can be added regardless of model.

### Solution to Problem

In order to solve the foregoing problems, a multifunction printer according to the present invention includes: display means; a web browser section that operates in accordance with a software for a web browser; a web server section that operates in accordance with a software for a web server; an application execution section that operates in accordance with at least one application which is executed on the web server; and a device control section for controlling a plurality of functions including a scan function, a print function, and an image data communication function, the web browser section performing a window display process for displaying in the display means an operation window indicated by window data obtained from the web server section and notifying the web server section of an application execution instruction entered into the operation window, as soon as the web server section has received the application execution instruction, the application execution section executing an application corresponding to the application execution instruction and, in accordance with the application, sending the device control section a control command to control at least one of the plurality of functions, the device control section performing control based on the control command.

### Advantageous Effects of Invention

The present invention makes it possible to provide a multifunction printer to which a function can be added regardless of model.

### BRIEF DESCRIPTION OF DRAWINGS

FIG. 1 is a block diagram showing an internal configuration of a multifunction printer according to the present embodiment.

FIG. 2 shows a configuration of a network system including a multifunction printer according to the present embodiment.

FIG. 3 is a flow chart showing the flow of a process that a multifunction printer performs.

FIG. 4 is a flow chart showing the flow of a business form process for storing scanned image data in a file server.

FIG. 5 shows a time series of data sent and received in a business form process.

FIG. 6(a) shows an example of a start window for starting a business form process.

FIG. 6(b) shows an example of an error display window that appears where there is no document.

FIG. 6(c) shows an example of a status display window showing that a process is in execution.

FIG. 6(d) shows an example of a termination window indicating the termination of a process.

FIG. 6(e) shows an example of an error window showing that an error has occurred during processing.

FIG. 7 shows a time series of data sent and received in a process for displaying an operation window corresponding to unique information.

FIG. 8 shows a time series of data sent and received in a specific example where the functions of a multifunction printer are restricted.

FIG. 9 shows a time series of data sent and received in a specific example where the print function of a multifunction printer is executed.

FIG. 10 shows an example where multifunction printers according to the present embodiment are applied.

### DESCRIPTION OF EMBODIMENTS

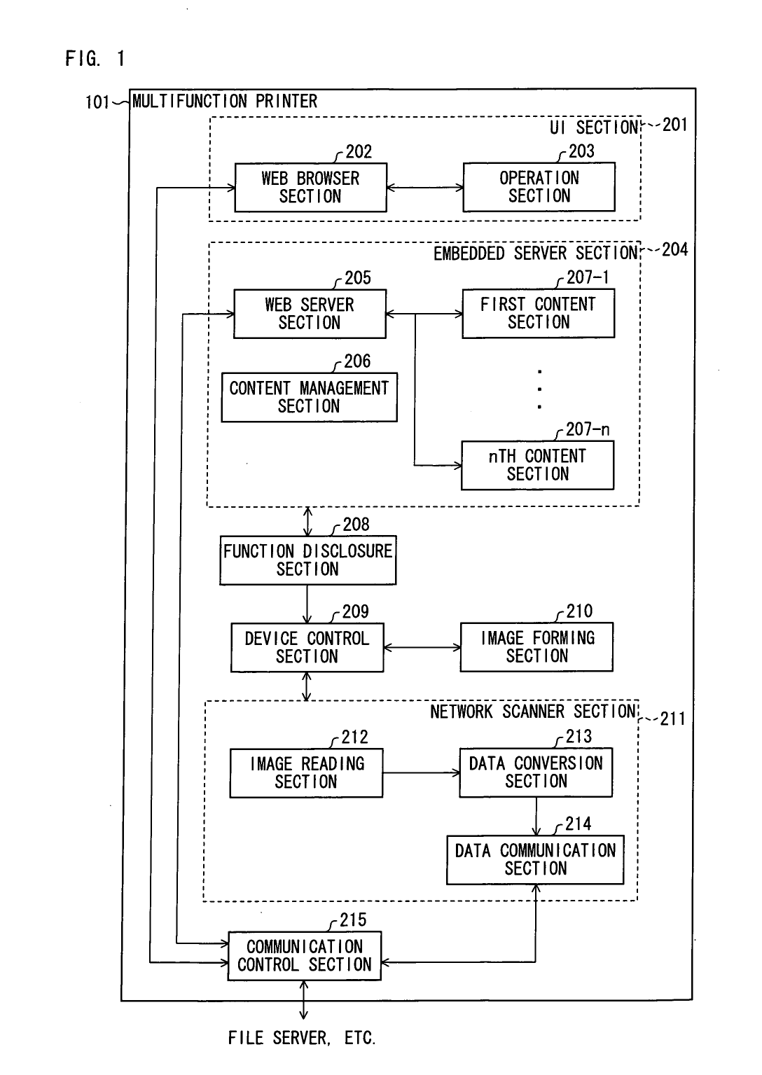

An embodiment of the present invention is described below with reference to FIGS. 1 through 7.

(System Configuration)

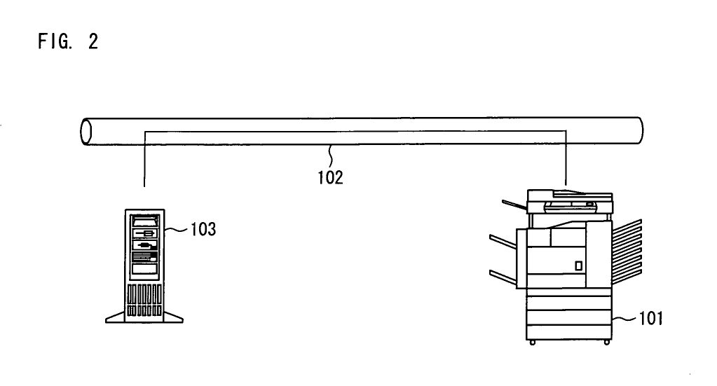

FIG. 2 shows a configuration of a network system including a multifunction printer 101 according to the present embodiment. As shown in FIG. 2, the multifunction printer 101 can communicate with a file server 103 through a communication network 102. A usable example of the communication network 102 is the Internet, a telephone line, a serial cable, or another communication line such as a cable line or a wireless line.

For example, the multifunction printer 101 can execute an image data filing process for sending image data read by scanning to the file server 103 and storing the image data in the file server 103, a print process for obtaining image data from the file server 103 and printing on a sheet of paper an image indicated by the image data thus obtained, etc.

(Configuration of the Multifunction Printer)

The following describes a configuration of the multifunction printer 101. The multifunction printer 101 is an apparatus capable of executing a plurality of functions such as a scan function, a print function, a facsimile sending and receiving function, and an image data sending and receiving (communication) function, and various functions can be executed through appropriate combinations of these functions. For example, a copy function can be realized through a combination of the scan function and the print function, and a function of storing scanned image data in an external storage device can be realized through a combination of the scan function and the image data sending and receiving function. It should be noted that the following description explains the scan function and the print function, which are the main functions of the multifunction printer 101, and omits to explain the other functions.

As shown in FIG. 1, the multifunction printer 101 includes a UI section 201, an embedded server section 204, a function disclosure section 208, a device control section 209, an image forming section 210, a network scanner section 211, and a communication control section 215.

The UI section 201 functions as a user interface. The UI section 201 includes a web browser section 202 and an operation section 203.

The web browser section 202 operates in accordance with software for general-purpose web browsers. The web browser section 202 sends a request to a web server and receives a response to the request through the communication control section 215. In the present embodiment, the web browser section 202 sends and receives data to and from the embedded server section 204, which is placed internally in the multifunction printer 101, mainly by using a loop back address. However, the web browser section 202 may send and receive data to and from an external web server apparatus.

The web browser section 202 sends an HTTP request (loop back call) to the communication control section 215 by a URL (uniform resource locator) containing the loop back address and application specifying information (parameters) for specifying an application embedded in the embedded server section 204. It should be noted that the application specifying information may contain information indicative of processing conditions necessary for processing in the application.

The operation section 203 serves to notify information of a user and receive input from the user. The operation section 203 may have a display section such as a liquid crystal display and an input section including various input keys independently of each other, or may be a touch panel integrally constituted by a display section and an input section.

The embedded server section 204 is a block that operates in accordance with a web server that is software for providing the function of a server constituting the WWW (World Wide Web), which is an information system on the Internet, and various applications that operate on the web server. As shown in FIG. 2, the embedded server section 204 includes a web server section 205, a content management section 206, and a content section 207 (first to nth content sections 207-1 to 207-n).

The web server section 205 operates in accordance with software for general-purpose web servers. The web server section 205 receives a request (HTTP request) from the web browser section 202 through the communication control section 215, executes an application corresponding to the request, and sends a response (HTTP response) to the web browser section 202.

It should be noted that the web server section 205 keeps monitoring instructions for the communication control section 215 to start communication, and when the communication control section 215 receives an HTTP request (loop back call addressed to the loop back address) constituted by the loop back address and application specifying information (parameters indicative of the content of the request), the web server section 205 recognizes the communication control section 215 as communicating with the web server section 205 and obtains the application specifying information. Further, since the web server section 205 responds to an HTTP request using the loop back address, the web server section 205 can respond to the web browser section 202 that sent the request.

The content section 207 serves to execute a predetermined process in accordance with an application corresponding to the content of an HTTP request received by the web server section 205. Examples of this application include a custom application written in Java (Registered Trademark) Script and an application that operates in a Java (Registered Trademark) script execution environment provided on a web server. The content section 207 is composed of first to nth content sections 207-1 to 207-n that operate in accordance with their respective applications. The web server section 205 analyzes the content of an HTTP request, selects an application for executing a process of the content, and activates a content section 207 corresponding to the application. Specifically, the web server section 205 needs only to select an application in accordance with the application specifying information contained in the HTTP request.

Then, the content section 207 executes the process corresponding to the HTTP request, generates an HTTP response corresponding to the HTTP request, and sends the response to the web browser section 202 through the web server section 205.

The content management section 206 serves to add or delete a content section 207 in accordance with input from the user. For example, the installation of a new application allows the content management section 206 to build in the embedded server section 204 a new content section 207 that operates in accordance with that application. Further, the uninstallation of an application that is no longer needed allows the content management section 206 to delete from the embedded server section 204 a content section 7 that operates in accordance with that application.

For each content section 207 registered in the embedded server section 204, the content management section 206 has stored therein correspondence information that associates (i) application identifying information for identifying an application for operating the content section 270 with (ii) a URL for activating the content section 207. Moreover, the content management section 206 makes an update to its correspondence information at the same time as it adds or deletes a content section 207.

Upon receiving a request for a list of expanded functions from the web browser section 202, the content management section 206 responds by reading out the stored correspondence information and generating HTML data on an operation window that shows a list of application identifying information contained in the correspondence information. It should be noted that the HTML data also contains a URL corresponding to each piece of application identifying information and an instruction for the web browser section 202 to execute a process based on the corresponding URL when that piece of application identifying information is selected.

The image forming section 210 serves to print an image (text/photograph/graphics) corresponding input image data on a recording sheet such as a sheet of paper, and includes a photoreceptor drum, a charging device, an exposure device, a developing device, a transfer device, a fixing device, a paper tray, etc.

The network scanner section 211 serves to execute the scan function and a function of sending scanned image data to the external file sever 103. It should be noted that the network scanner section 211 may simply execute the scan function alone. As shown in FIG. 1, the network scanner section 211 includes an image reading section 212, a data conversion section 213, and a data communication section 214.

The image reading section 212, which includes a scanner and a document carrying section for carrying a document to the position of the scanner, serves to read, as image data, characters and/or images printed on a document.

The data conversion section 213 serves to covert image data read by the image reading section 212 into a predetermined format of image data (e.g., PDF or TIFF).

The data communication section 214 serves to send the image data converted by the data conversion section 213 to a designated storage device (such as the file server 103) through the communication control section 215 and store the image data in a designated folder.

The function disclosure section 208, which discloses to the content section 207 a control command to control the various functions of the multifunction printer 101, serves to receive a control command from the content section 207 and convert the control command thus received into a command that can be recognized by the device control section 209.

The function disclosure section 208, which includes a conversion table storage section (not shown) having stored therein a conversion table that associates each externally disclosed control command with a command that can be recognized by the device control section 209, performs a process for converting a command in accordance with the conversion table.

As such, the function disclosure section 208 can receive a common command regardless of the model of multifunction printer 101. This makes it possible to use a common application for operating each content section 207 of any multifunction printer 101. For this reason, in cases where the content management section 206 adds to the embedded server section 204 a content section 207 that operates in accordance with a new application, it is only necessary to install the same application in each multifunction printer 101; therefore, it is no longer necessary to change applications for each multifunction printer 101. This makes it possible to easily develop an application for operating a content section 7.

The device control section 209 serves to control the various functions of the multifunction printer 101. Specifically, the device control section 209 controls the operation of the network scanner section 211, the image forming section 210, the communication control section 215, the operation section 203, etc.

For example, the device control section 209 controls the operation of the image reading section 212 to obtain data on a scanned image. Further, the device control section 209 controls the network scanner section 211 and the communication control section 215 to convert scanned image data into a predetermined format and store the image data thus converted in a designated folder of the file server 103. Furthermore, the device control section 209 controls the operation of the image forming section 210 to form on a sheet of paper an image indicated by input image data and output the image. Furthermore, the device control section 209 uses the communication control section 215 to attach image data to an e-mail and send the e-mail to a designated address.

The device control section 209 can operate in either a unique operation mode or a custom operation mode. The unique operation mode is a mode by which the device control section 209 causes the operation section 203 to display an operation window unique to the multifunction printer 101 and stored in advance in the multifunction printer 101 and performs such control as described above in accordance with an instruction entered into the operation window. This unique operation mode is a general mode in which a conventional multifunction printer 101 operates, and as such, is not described in detail here.

On the other hand, the custom operation mode is a mode by which the device control section 209 causes the operation section 203 to display an operation window that the web browser section 202 has received from the embedded server section 204, receives a control command that the embedded server section 204 has sent in accordance with an instruction entered into the operation window, and performs control based on the control command. In the custom operation mode, the embedded server section 204 is used; therefore, various functions can be added by installing various applications in the embedded server section 204 to add new content sections 207. Further, the embedded server section 204 also provides an operation window; therefore, in the case of development of an operation window more convenient for users, the old operation window can be easily replaced with the new operation window by installing data indicative of the new operation window in the embedded server section 204.

In response to an instruction to operate in the custom operation mode, the device control section 209 activates the web browser section 202 and causes the web browser section 202 to execute a process based on a preset URL (which, in the present embodiment, contains the loop back address and requests sending of an initial operation window). Moreover, in the custom operation mode, the device control section 209 receives a control command from the content section 207 through the function disclosure section 208 and performs control based on the control command.

The communication control section 215, constituted by an NIC (network interface card), serves to control communication. It should be noted that the communication control section 215 controls communication between the web browser section 202 and the web server section 205 according to a protocol for use in general-purpose web browsers and web servers (HTTP: hypertext transfer protocol).

(Flow of a Process in the Custom Operation Mode)

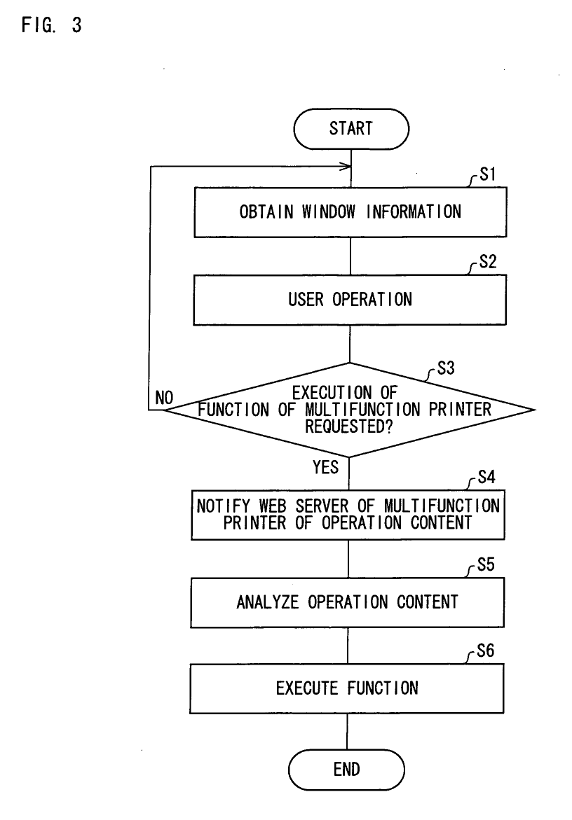

The following describes the flow of a process in the custom operation mode. FIG. 3 is a flow chart showing the flow of a process that the multifunction printer 101 performs in the custom operation mode.

First, as soon as the operation section 203 has received an instruction to start the custom operation mode, the device control section 209 activates the web browser section 202 and causes the web browser section 202 to execute a process based on a URL that requests a list of expanded functions. Specifically, the web browser section 202 generates an HTTP request for a list of expanded functions and sends the HTTP request to the web server section 205 by using the loop back address. Then, upon receiving the HTTP request, the content management section 206 responds with HTML data on an operation window that shows a list of application identifying information contained in the stored correspondence information, whereby the web browser section 202 displays in the operation section 203 an operation window that shows a list of applications registered in the embedded server section 204.

Then, in response to an instruction to select one of the pieces of application identifying information, the web browser section 202 specifies from the HTML data a URL corresponding to the piece of application identifying information thus selected and executes a process based on the URL.

It should be noted here that every URL that corresponds to a piece of application identifying information contains the loop back address (127.0.0.1) as an address to be accessed, and contain an execution instruction to the corresponding content section 207. Therefore, the web browser section 202 sends an HTTP request for execution of an application designated by the URL to the web server section 205 through the communication control section 215.

Then, as soon as the web server section 205 has received the HTTP request, the content section 207 specified by the application specifying information of the HTTP request generates HTML data indicative of an operation window as a response to the request and responds to the web browser section 202 through the communication control section 215. Then, the web browser section 202 causes the operation section 203 to display the operation window indicated by the HTML data thus received (S1).

Next, the operation section 203 receives input that the user enters into the operation window thus displayed (S2).

After that, if the input from the user is an instruction that requests a next operation window and is not an instruction to control the various functions of the multifunction printer 101 (No in S3), Steps S1 and S2 are repeated.

On the other hand, if the input from the user is an instruction to control the various functions of the multifunction printer 101 (Yes in S3), the web browser section 202 sends notification to the web server section 205 accordingly by using the loop back address (S4).

Specifically, the content section 207 has set as the loop back address an address to be accessed when a button to give an instruction to control the various functions of the multifunction printer 101 is pressed in the HTML data on the operation window with which the content section 207 responded in S1. Accordingly, when the button to give an instruction to control the various functions is pressed in the operation window, the web browser section 202 can access the web server section 205 in accordance with the loop back address to notify the web server section 205 of the instruction to control the various functions.

After that, the content section 207 analyzes the content of the control instruction sent from the web browser section 202 (S5).

Then, the content section 207 generates, in accordance with a result of the analysis, a control command to control the functions of the multifunction printer 101, and then sends the control command to the function disclosure section 208. Upon receiving the control command, the function disclosure section 208 converts the control command into a command that can be recognized by the device control section 209. After that, the device control section 209 controls the various functions in accordance with the command thus converted (S6).

As described above, the multifunction printer 101 includes: an operation section (display means) 203: a web browser section 202 that operates in accordance with software for a web browser; a web server section 205 that operates in accordance with software for a web server; a content section (application execution section) 207 that operates in accordance with at least one application which is executed on the web server; and a device control section 209 for controlling a plurality of functions including a scan function, a print function, and an image data communication function.

Moreover, the web browser section 202 displays in the operation section 203 an operation window indicated by window data obtained from the web server section 205 and notifies the web server section 205 of an application execution instruction entered into the operation window. Then, as soon as the web server section 205 has received the application execution instruction, the content section 207 executes an application corresponding to the execution instruction and, in accordance with the application, sends the device control section 209 a control command to control at least one of the plurality of functions. Then, the device control section 209 performs control based on the control command as converted by the function disclosure section 208. This allows the device control section 209 to control the various functions of the multifunction printer 101. For example, the device control section 209 can execute the scan function, the print function, etc.

Moreover, the web browser section 202 needs only to operate in accordance with software for web browsers, and the web server section 205 needs only to operate in accordance with software for web servers. As such, the web browser section 202 can be realized by a general-purpose web browser, and the web server section 205 can be realized by a general-purpose web server. It is not necessary to uniquely expand the general-purpose web browser. Further, even in the case of a version upgrade or change in the general-purpose web browser or web server, it is only necessary to make the version upgrade or change, and no other maintenance is needed.

Further, the installation of a new application in the multifunction printer 101 makes it possible to execute the new application by using the web browser section 202 and the web server section 205. This application is executed on the web server. Moreover, as mentioned above, the web server section 205 of each multifunction printer 101 can use software for general-purpose web servers. This makes it only necessary to install the same application regardless of the model of each multifunction printer 101. This makes it possible, as a result, to easily add a function to each multifunction printer 101 through an application.

### Specific Example Process 1

### Business Form Process

The following describes the flow of a specific example process. This specific example is described as an example where a process for storing scanned image data in the file server 103 is executed in the custom operation mode by controlling the scan function and image data communication function of the multifunction printer 101. It should be noted that a normal network scanner function requires various parameters to be set for a job to be executed but, in the case of processing of templates such as forms, such a simple mode of operation is desired as to omit those procedures. Accordingly, this specific example is described by taking as an example a case where the embedded server section 204 has registered in advance therein a content section 207 that operates in accordance with an application (function enhancement content “business form process”) which provides such a mode of operation. It should be noted here that the “business form process” application is intended to read a fixed-form document placed on a document tray of a document reading section of the multifunction printer 101, send the document to the file server 103, and store the document in the file server 103.

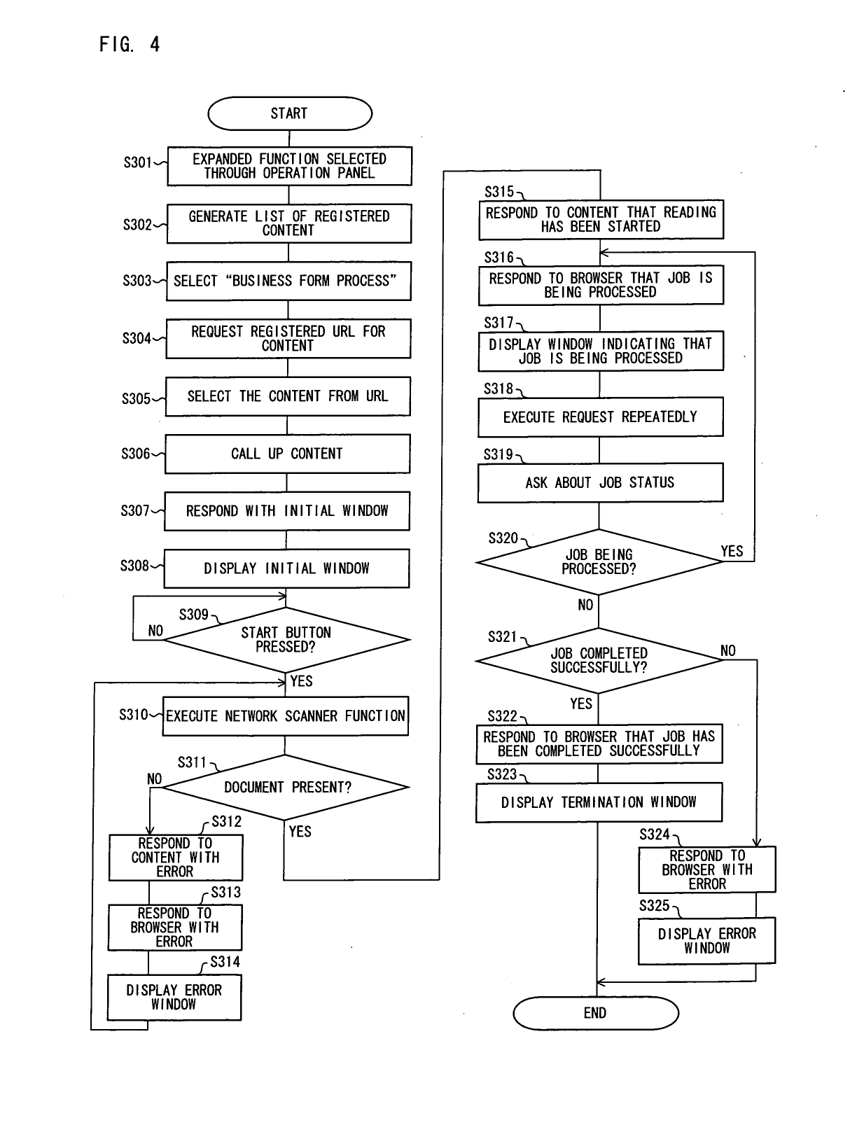

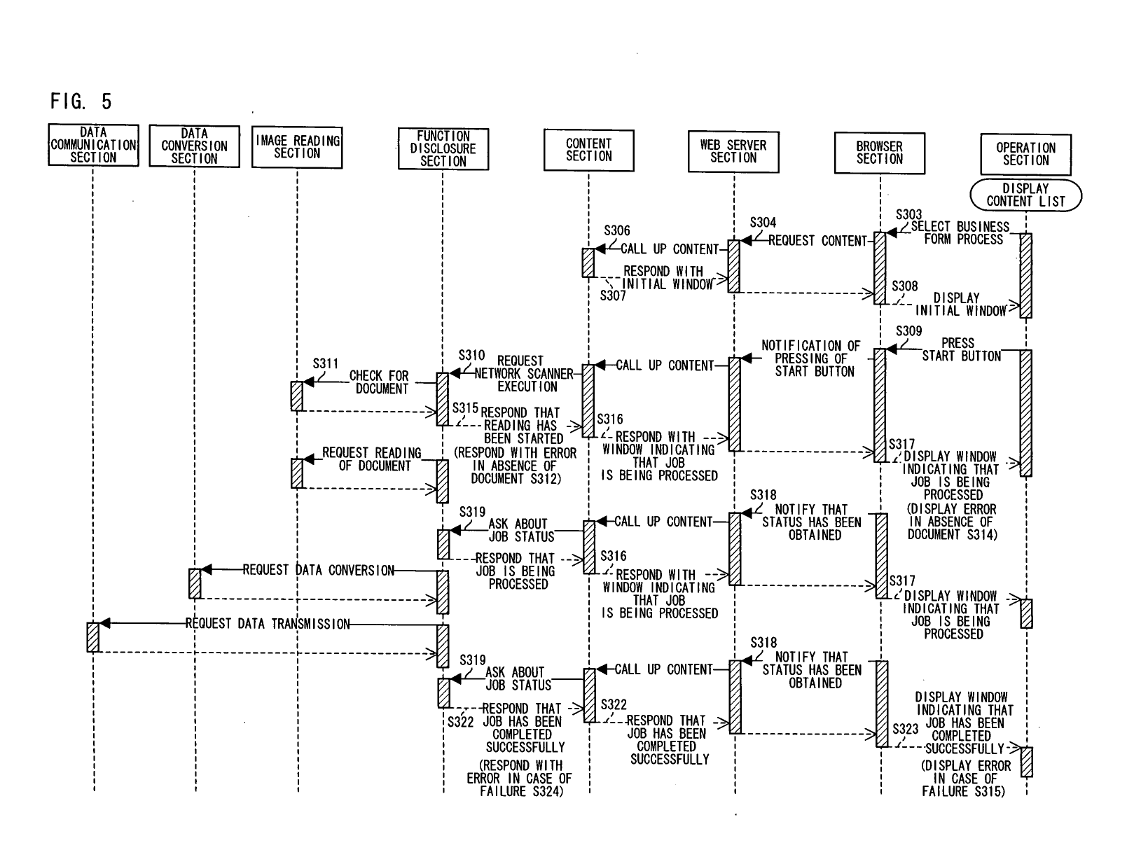

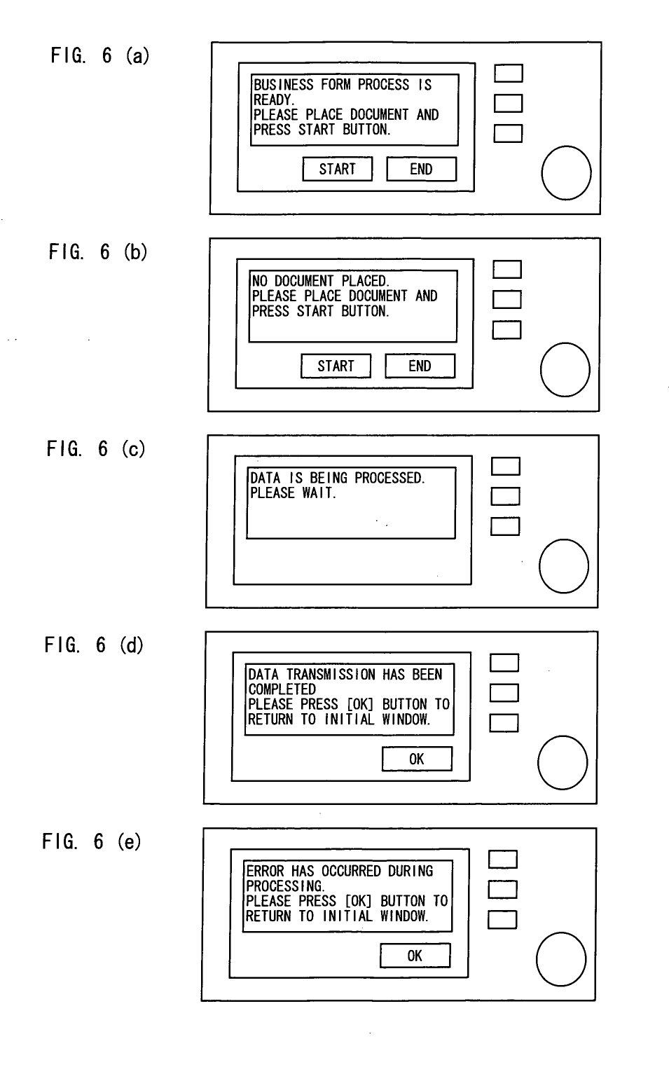

FIG. 4 is a flow chart showing the flow of a business form process in the custom operation mode. FIG. 5, which corresponds to FIG. 4, is a diagram (sequence diagram) showing a time series of data sent and received. FIG. 6(a) through (e) show examples of operation windows.

First, as soon as the operation section 203 has received an instruction to start the custom operation mode (S301), the web browser section 202 requests the embedded server section 204 for an operation window that shows a list of registered applications, and then displays the operation window in the operation section 203 (S302).

Let it be assumed here that the “business form process” has been selected. Then, the web browser section 202 specifies a URL (e.g., http://127.0.0.1/scan/scanexe) corresponding to the “business form process” in accordance with the HTML data sent from the embedded server section 204 in S302, and then executes a process based on the URL (S303). It should be noted here that the URL contains the loop back address as an address to be accessed and application specifying information specifying the application corresponding to the “business form process”.

After that, the web browser section 202 accesses the loop back address in accordance with the URL thus set and sends an HTTP request containing the application specifying information to the communication control section 215. The web server section 205, which monitors HTTP requests to the communication control section 215, receives the HTTP request from the web browser section 202 as soon as it has recognized that the HTTP request contains the loop back address (S304).

In accordance with the HTTP request from the web browser section 202, the web server section 205 specifies the application indicated by the application specifying information. Specifically, the web server section 205 specifies the application in accordance with the URL (S305). For example, in cases where the URL is http://127.0.0.1/scan/scanexe, the web server section 205 needs only to specify the application indicated by “scanexe” as an application requested to be executed.

Then, the web server section 205 calls up a content section 207 that operates in accordance with the application thus specified (S306).

As a response to the HTTP request from the web browser section 202, the content section 207 thus called up generates HTML data indicative of an operation window for starting the business form process and sends the HTML data to the web server section 205 (S307). After that, the web server section 205 sends an HTTP response containing the HTML data to the web browser section 202. Upon receiving the HTML data, the web browser section 202 displays in the operation section 203 the operation window indicated by the HTML data (S308). FIG. 6(a) shows an example of the operation window that is displayed in S308.

It should be noted here that as a URL that is accessed when the “START” button on the window of FIG. 6(a) is pressed, the HTML data that is sent in S307 has set therein a URL containing the loop back address as an address to be accessed and a request for execution of the scan function.

Therefore, when the “START” button is pressed in the operation section 203 (Yes in S309), the web browser section 202 sends an HTTP request containing the request for execution of the scan function to the web server section 205 through the communication control section 215 in accordance with the URL. In so doing, the web browser section 202 incorporates, into the HTTP request, job conditions including (i) reading resolution designated by the user in the operation window, (ii) the address of the file server 103 designated as a destination, and (iii) a method for designating a file name (e.g., a method for giving a file name according to date, time, etc.).

Then, the web server section 205 calls up the content section 207 in accordance with the URL in the same manner as in S306 and notifies the content section 207 of the request for execution of the scan function. Upon receiving the request for execution of the scan function, the content section 207 checks for the presence of a document and, if a document is present, sends the function disclosure section 208 a control command to start reading of the document (S310).

The function disclosure section 208 converts the control command thus received into a command that can be recognized by the device control section 209, and then sends the control command to the device control section 209. Then, the device control section 209 determines the type of the control command and activates the network scanner section 211. Specifically, the image reading section 212 uses a document detection sensor to determine whether or not there is a document placed on a platen (S311).

If there is no document placed on the platen (No in S311), the image reading section 212 notifies the content section 207 of an error indicative of the absence of a document through the function disclosure section 208 (S312). Upon receiving the error indicative of the absence of a document, the content section 207 generates HTML data indicative of an operation window that prompts the user to place a document on the platen, and then responds to the web browser through the web server section 205 (S313). Then, the web browser section 202 displays the operation window in the operation section 203 in accordance with the HTML data (S314). FIG. 6(b) shows an example of the operation window that is displayed in S314.

On the other hand, if there is a document placed on the platen (Yes in S311), the image reading section 212 starts an operation for reading the document and sends notification of start of reading to the content section 207 through the function disclosure section 208 (S315). In so doing, the image reading section 212 newly obtains a unique job ID for identifying a job and incorporates the job ID into the notification of start of reading.

Upon receiving the notification of start of reading, the content section 207 sends, through the web server section 205 to the web browser section 202, an HTTP response containing HTML data indicative of an operation window that shows that the reading is being processed (S316). Then, the web browser section 202 displays the operation window in the operation section 203 in accordance with the HTML data (S317). FIG. 6(c) shows an example of the operation window that is displayed in S317.

It should be noted that the content section 207 incorporates, into the HTTP response of S316, an instruction to repeat a “request for status confirmation” after a certain period of time.

Specifically, because among the functions of general-purpose web browsers and web servers there is a function of “making a call to a designated URL x seconds later” according to an HTTP command, this function can be used for the content section 207 to instruct the web browser section 202 to make a request to obtain a window that shows the progress of a job being executed. Then, in response to the request for status confirmation from the web browser section 202, the content section 207 sends HTML window data to the web browser section 202. The HTML window data allows the web browser section 202 to change from displaying a window “JOB IS BEING PROCESSED” to displaying a window “JOB HAS BEEN COMPLETED”. Even when there are a plurality of jobs being performed concurrently, they can be distinguished by job IDs; therefore, by describing the job IDs in a query part of the URL of the request for status confirmation from the web browser section 202, the jobs can be distinguished by the job IDs and a response can be made for each job as to whether the job has been completed or has not yet been completed.

Meanwhile, the network scanner section 211 reads the document as a background under the designated job conditions, performs data conversion, and sends the data under the designated file name. Further, the network scanner section 211 also discloses a function of receiving an inquiry into the current status of a job, by using the job ID returned in response to the execution request, and can make a response through the function disclosure section 208 as to whether the job identified by the designated job ID is being processed, has been completed, or has been terminated with error.

Thus, after a certain period of time, the web browser section 202 uses the loop back address to send the web server section 205 an HTTP request containing a request for confirmation of the status of the job (S318). Then, the content section 207, called up by the web server section 205 in the same manner as in S306, designates a job ID to ask the function disclosure section 208 about the job status (S319).

As mentioned above, the network scanner section 211 discloses the function of receiving an inquiry into the status of a job. Therefore, the function disclosure section 208 can make a response as to whether the job identified by the designated job ID is being processed, has been completed, or has been terminated with error (S320, S321).

If the job is being processed (Yes in S320), the process returns to S316. Alternatively, if the job has been terminated with error (No in S320, No in S321), the content section 207 generates HTML data indicative of an error window and responds to the web browser section 202 through the web server section 205 (S324). This causes the web browser section 202 to display in the operation section 203 such an error window as shown in FIG. 6(e) (S325).

Alternatively, if the job has been completed (No in S320, Yes in S321), the content section 207 generates HTML data indicative of a completion notification window that shows the job has been completed successfully, and then responds to the web browser section 202 through the web server section 205 (S322). This causes the web browser section 202 to display in the operation section 203 such a completion notification window as shown in FIG. 6(d) (S323).

As described above, in this specific example, the web browser section 202 displays in the operation section 203 a scan start operation window for receiving an instruction for the image reading section 212 to start a reading operation. Then, the web browser section 202 notifies the web server section 205 of the instruction, entered by the user, for the image reading section 212 to start a reading operation. As soon as the web server section 205 has received the instruction to start a reading operation, the content section 207 sends, through the function disclosure section 208 to the device control section 209, a control command for the image reading section 212 to start a reading operation. This allows the multifunction printer 101 to execute a scan.

### Specific Example Process 2

### Modification of Specific Example 1

This specific example is a modification of Specific Example 1 described above. Multifunction printers vary in performance from model to model. Therefore, in Specific Example 1, in order for the multifunction printer to display an operation window depending on its model, the content section 207 needs to have stored therein HTML data on an operation window corresponding to the model of multifunction printer. Alternatively, the content section 207 needs to have stored therein HTML data on an operation window corresponding to the model of each multifunction printer, and the web browser section 202 needs to send an HTTP Get command that requests an initial operation window corresponding to the model of multifunction printer 101 in which the web browser section 202 is provided. In this case, it is necessary to create a program corresponding to an operation window for the model of each multifunction printer in creating an application for operating the content section 207, but this require a great deal of effort and time. This specific example is an example where it is not necessary to consider the model of multifunction printer in creating an application for operating the content section 207.

In this specific example, the function disclosure section 208 discloses to the content section 207 unique information indicative of the performance of the multifunction printer 101 (e.g., a parameter list of degrees of reading resolution of the image reading section, etc.) and passes the unique information to the content section 207 in response to a request from the content section 207. Upon receiving from the web browser section 202 a request to send an operation window, the content section 207 needs only to receive from the function disclosure section 208 the unique information indicative of the performance of the multifunction printer 101 and generate HTML data on an operation window in accordance with the unique information. This makes it possible to share a common application for operating the content section 207 regardless of the model of multifunction printer. This makes it possible, as a result, to use the same application for operating the content section 207 for each of the multifunction printers of different models, and makes it easy to create the application. The following describes a specific example where the unique information is applied to the business form process described in Specific Example 1.

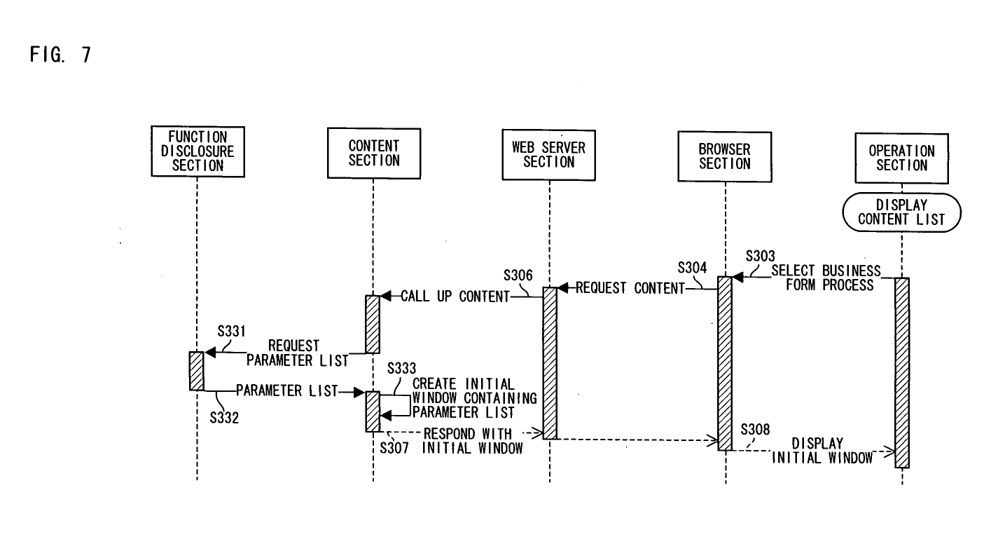

This specific example is characterized in Steps S306 and S307 of Specific Example 1 shown in FIG. 4. Other than these characteristics, this specific example is identical to Specific Example 1. Therefore, only steps different from those shown in Specific Example 1 are described. FIG. 7 shows the flow of steps in a characteristic part of this specific example.

The content section 207, called up by the web server section 205, requests the function disclosure section 208 for unique information (which is here a parameter list indicative of degrees of reading resolution) (S331). Then, the content section 207 obtains the unique information from the function disclosure section 208 (S332).

After that, the content section 207 generates HTML data indicative of an operation window based on the unique information (S333). For example, the content section 207 can generates HTML data indicative of an operation window for selecting one of the degrees of reading resolution contained in the unique information. Then, the content section 207 needs only to sends an HTTP response containing the operation window thus generated to the web browser section 202 through the web server section 205 (S307). This allows the web browser section 202, as a result, to display in the operation section 203 an operation window corresponding to the model of multifunction printer.

It should be noted that the content section 207 may have the unique information (which is a parameter list of degrees of reading resolution in this specific example) stored in advance therein.

As described above, in this specific example, the function disclosure section (storage section) 208 has stored therein unique information indicative of the performance of the multifunction printer 101. Moreover, when the web server section 205 receives from the web browser section 202 a request to send an initial operation window, the content section (application execution section) 207 obtains the unique information from the function disclosure section 208 and generates window data indicative of an operation window based on the unique information thus obtained. After that, the web server section 205 sends the window data to the web browser section 202. This allows the web browser section 202 to display the operation window based on the unique information.

Since the content section 207 thus obtains unique information such as degrees of reading resolution from the function disclosure section 208, an application for creating an operation window can be designed for general purposes regardless of the model of multifunction printer. Furthermore, since the content section 207 creates an operation window in accordance with the unique information, the multifunction printer can easily display an operation window according to its model.

### Specific Example Process 3

### Authentication Application

This specific example serves to restrict the various functions of the multifunction printer 101 in accordance with a result of an authentication process by authentication information. Possible cases of restriction of the various functions of the multifunction printer 101 are, for example, a case where color copying is prohibited and only monochrome copying is allowed to be executed, a case where the number of copies is restricted to a predetermined number (e.g., 100), etc.

A content section 207 that operates in accordance with a restriction process application has stored in advance therein a restriction table that associates each user name with restriction information indicative of restriction of the various functions of the multifunction printer 101. For example, the content section 207 has stored therein a restriction table that associates a user name “AAA” with restriction information indicative of prohibition of color copying and a user name “BBB” with restriction information indicating that an upper limit on the number of copies is 100.

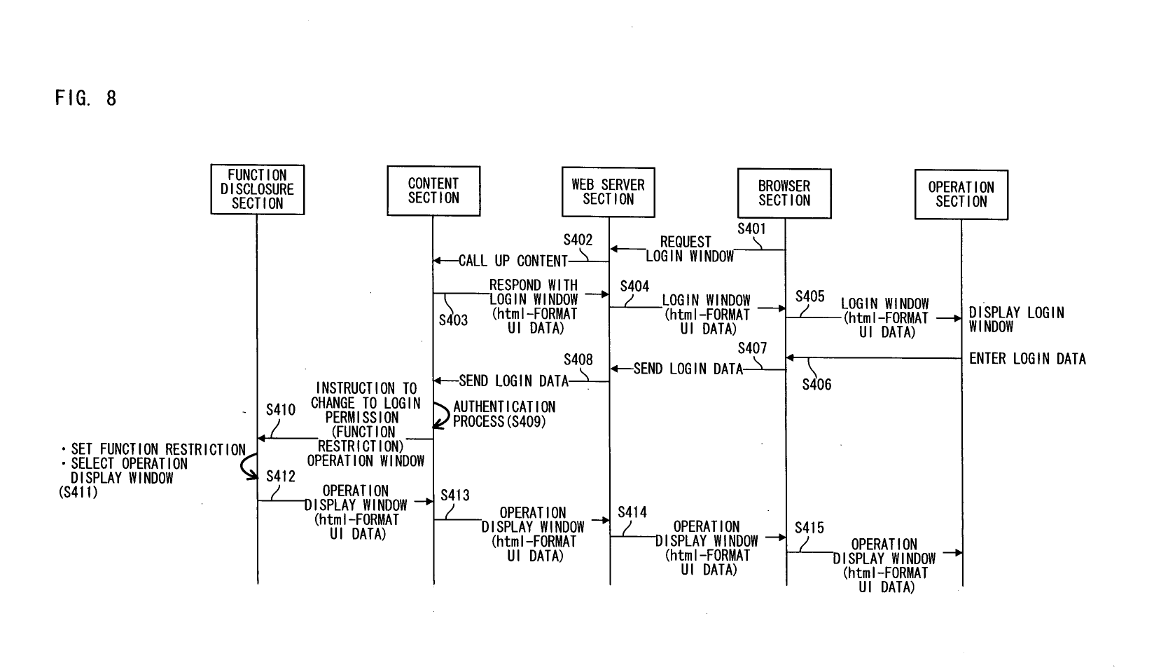

When having succeeded in authentication, the content section 207 reads out restriction information corresponding to the user name from the restriction table. Then, the content section 207 sends the function disclosure section 208 a control command to execute restriction indicated by the restriction information thus read out. The following describes the flow of a process in this specific example with reference to FIG. 8.

First, the operation section 203 receives an instruction to start the custom operation mode, and the web browser section 202 sends the web server section 205 an HTTP Get command to get login window data for function restriction (S401).

Upon receiving the Get command, the web server section 205 activates the content section 207 corresponding to the restriction process application (S402). Then, the content section 207 in return sends HTML data corresponding to a login window for function restriction corresponding to the Get command to the web browser section 202 through the web server section 205 (S403, S404). The web browser section 202 displays the login window for function restriction in the operation section 203 in accordance with the HTML data thus received (S405).

The login window is, for example, a window containing a space in which to enter a user name, a space in which to enter a password, and a “login” button for starting login.

When a user name and a password are entered onto the login window and the “login” button is pressed (S406), the web browser section 202 sends the authentication information thus entered (which is here the user name and the password) to the web server section 205 in accordance with a URL described in the HTML data received in S404 (S407). As will be described later, the authentication information serves to restrict the functions of the multifunction printer 101 and therefore can be said to be an instruction to restrict the functions of the multifunction printer 101.

The web server section 205 sends the authentication information thus received to the content section 207 activated (called up) in S402 (S408). Upon receiving the authentication information, the content section 207 checks whether the authentication information matches the prestored user name and the prestored password and performs an authentication process for, if it does, determining that authentication has been completed successfully or for, if it does not, determining that authentication has ended up in failure (S409). Then, when authentication has been completed successfully, the content section 207 reads out, from the prestored restriction table, restriction information corresponding to the user name indicated by the authentication information.

Then, the content section 207 generates a control command to execute function restriction based on the restriction information read out from the restriction table and to change to an operation window corresponding to the restriction information, and then sends the control command to the function disclosure section 208 (S410). Then, the function disclosure section 208 converts the control command thus received into a command that can be recognized by the device control section 209, and then sends the command to the device control section 209.

The device control section 209 sets function restriction based on the control command (S411). Furthermore, the device control section 209 has stored in advance therein a window table that associates each piece of restriction information with a piece of HTML-format image data indicative of an operation window corresponding to that piece of restriction information. Then, the device control section 209 reads out, from the window table, window data corresponding to the restriction information indicated by the control command, and then sends the window data to the content section 207 (S412).

For example, when the control command indicates prohibition of color copying, the device control section 209, in S411, does not receive an instruction to execute color copying. Alternatively, the device control section 209 controls the image reading section 212 and the image forming section 210 so that monochrome copying is executed when an instruction to execute color copying is received. Furthermore, in S412, the device control section 209 reads out, from the window table, HTML-format window data indicative of an operation window that can receive only an instruction to execute monochrome copying, and then sends the window data to the content section 207.

Alternatively, when the control command indicates that an upper limit on the number of copies is 100, the device control section 209, in S411, counts the number of sheets of paper printed in the image forming section 210 and, when the number reaches 100, controls the image forming section 210 so that no further print process is executed. Furthermore, in S412, the device control section 209 reads out, from the window table, HTML-format window data indicative of an operation window containing a message indicating that an upper limit on the number of copies is 100, and then sends the window data to the content section 207.

Then, the content section 207 sends, through the web server section 205 to the web browser section 202, the window data received from the device control section 209 as an HTTP response to the HTTP request of S407 (S413, S414). This causes the web browser section 202, as a result, to display in the operation section 203 an operation window indicated by the window data (S415).

As described above, in this specific example, the web browser section 202 displays in the operation section 203 a login window (authentication information entry window) that prompt a user to enter authentication information for user authentication. Furthermore, upon entry of authentication information into the login window, the web browser section 202 sends the web server section 205 an instruction to restrict the function of at least either the image reading section 212 and the image forming section 210, the instruction corresponding to a user indicated by the authentication information. As soon as the web server section 205 has received the authentication information, the content section 207 specifies, from the prestored restriction table (correspondence information) that associates each piece of authentication information with a piece of restriction information indicative of a method for restricting the functions of the multifunction printer 101, restriction information corresponding to the authentication information thus received, and then sends, through the function disclosure section 208 to the device control section 209, a control command to control at least either the image reading section 212 and the image forming section 210 in accordance with a restriction method indicated by the restriction information.

The foregoing configuration makes it possible, for example, to prohibit color copying and/or restrict the number of copies to 100 according to users.

### Specific Example Process 4

### Authentication Print Application

This specific example is an example where the file server 103 has stored in advance therein print data to be printed and a user operates the multifunction printer 101 to execute a process for printing the print data. Executability of such a process makes it possible to, simply by storing print data to be printed in advance in the file server 103, operate a multifunction printer 101 installed in a meeting room and thereby obtain printed matter on the spot, for example, in the case of urgent need of the printed matter during a meeting. Accordingly, this specific example is described by taking as an example a case where the embedded server section 204 has registered in advance therein a content section 207 that operates in accordance with an application (function enhancement content “authentication print application”) which provides such a mode of operation. It should be noted here that the “authentication print application” is intended to obtain designated print data from the file server 103 and print on a sheet of paper an image indicated by the print data thus obtained.

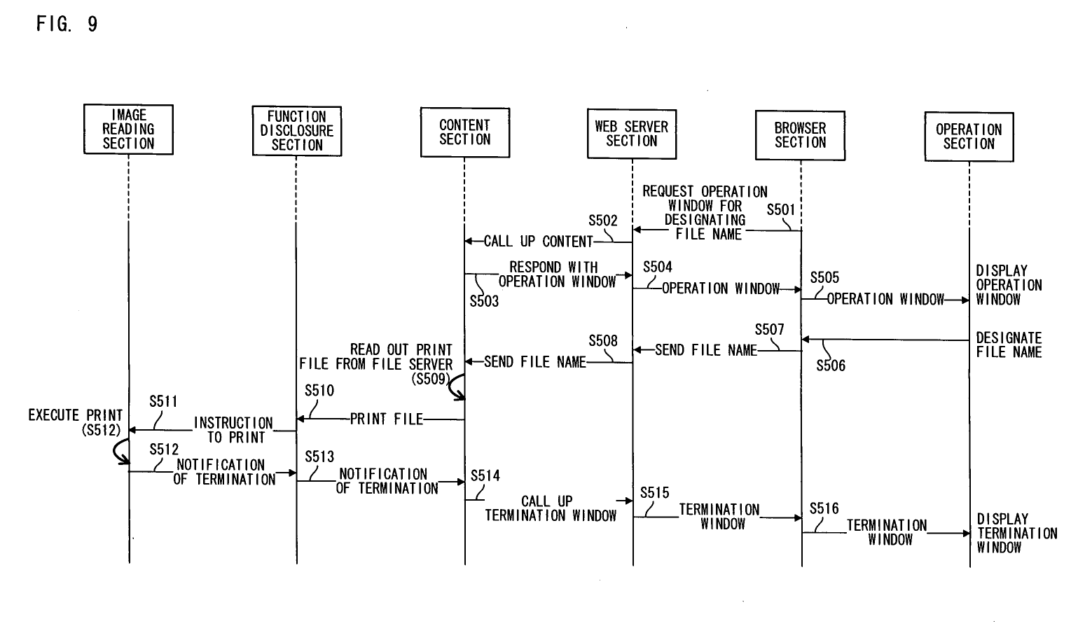

The following describes the flow of a process in this specific example with reference to FIG. 9. It should be noted that prior to this specific example process, the user stores print data in advance in a storage section of the file server 103.

First, the operation section 203 receives an instruction to stat the custom operation mode, and the web browser section 202 requests the embedded server section 204 for an operation window that shows a list of registered applications, and then displays the operation window in the operation section 203. Let it be assumed here that the “authentication print application” has been selected. Then, in response to this input, the web browser section 202 sends the web server section 205 an HTTP Get command that requests an operation window (image data selection window) for designating print data (S501).

Upon receiving the HTTP Get command, the web server section 205 analyzes the Get command and activates the content section 207 corresponding to the authentication print application (S502). Then, the content section 207 sends, as an HTTP response through the web server section 205 to the web browser section 202, HTML data indicative of the image data selection window requested (S503, S504).

In accordance with the HTML data thus received, the web browser section 202 displays in the operation section 203 the image data selection window for designating print data (S505). The user enters, onto the image data selection window, the address and folder name of the file server 103 in which image data to be printed (referred to also as print data or specific image data) has been stored and the file name of the print data (S506). The web browser section 202 sends the web server section 205 an HTTP Get command (print instruction), containing the file server name, folder name, and file name thus entered, which requests printing of the print data (S507).

The web server section 205 notifies the content section 207, which was activated in S502, of the file server name, the folder name, and the file name (S508). The content section 207 reads out the requested print data from the file server 103 in accordance with the information of which the content section 207 has been notified (S509). Then, the content section 207 generates a control command containing the print data thus read out and an instruction to execute printing of the print data, and then sends the control command to the function disclosure section 208 (S510). The function disclosure section 208 converts the control command into a command that can be recognized by the device control section 209, and then sends the control command to the device control section 209.

Then, the device control section 209 executes a print process based on the control command (S512). Specifically, the device control section 209 sends the print data to the image forming section 210, and then controls the image forming section 210 so that the image forming section 210 prints on a sheet of paper an image indicated by the print data.

Upon receiving notification of termination of printing from the image forming section 210 (S512), the device control section 209 sends the notification of termination to the content section 207 (S513). Upon receiving the notification of termination, the content section 207 generates HTML data indicative of a termination window as a response to the HTTP request of S507, and then sends the HTML data to the web browser section 202 through the web server section 205 (S514, S515). This allows the web browser section 202 to display the termination window in the operation section 203 (S516).

As described above, in this specific example, the web browser section 202 displays in the operation section 203 an image data selection window for specifying image data to be printed. Then, upon entry in the image data selection window of specifying information for specifying the image data, the web browser section 202 sends the web server section 205 an instruction to print an image indicated by print data indicated by the specifying information. As soon as the web browser section 205 has received the print instruction, the content section 207 obtains the print data, and then sends, through the function disclosure section 208 to the device control section 209, a control command to print the image indicated by the print data.

Thus, storage of print data in advance in the file server 103 makes it possible to obtain, from a plurality of multifunction printers 101, sheets of paper (recording sheets) on each of which an image indicated by the print data has been printed.

### Applied Example

The foregoing description has dealt with a configuration in which the web browser section 202 and the web server section 205, which are placed internally in the multifunction printer 101, communicate with each other. However, the web browser section 202 and the web server section 205 may communicate with a web server section 205 and a web browser section 202, respectively, that are placed in another multifunction printer or an external information processing apparatus. As described above, the web browser section 202 operates in accordance with software for general-purpose web browsers, and the web server section 205 operates in accordance with software for general-purpose web servers; the web browser section 202 and the web server section 205 use HTTP, which is a communication protocol for use in the general-purpose web browsers. This makes it possible to, simply by changing the address to be accessed contained in the URL, communicate with an external multifunction printer and an external information processing apparatus through an Internet line.

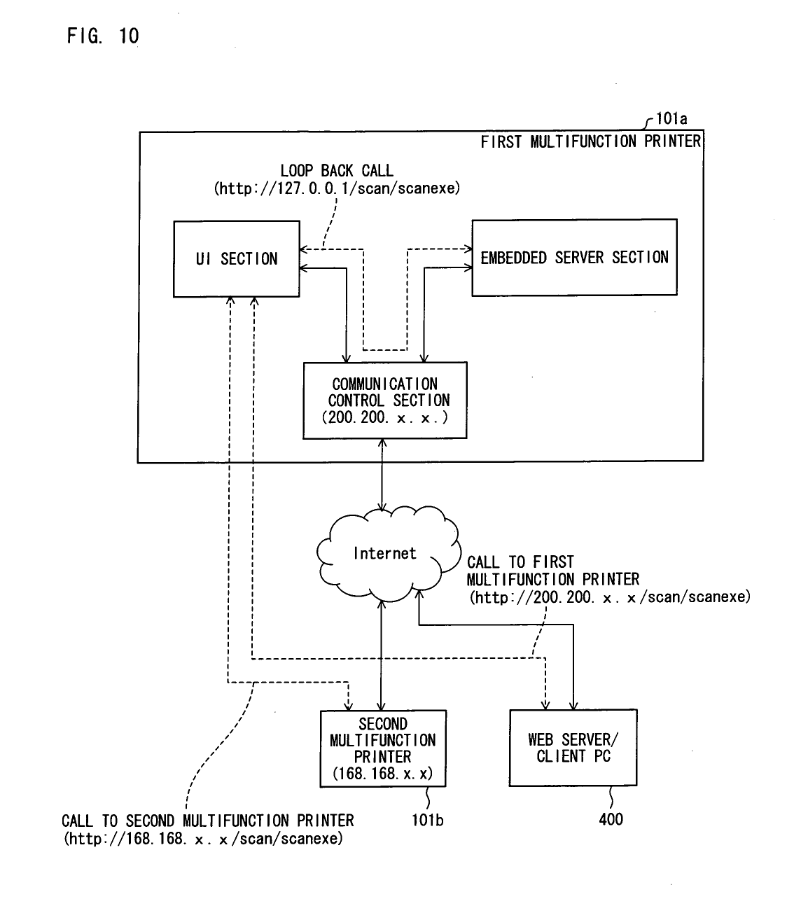

FIG. 10 shows a system configuration for communicating with an external multifunction printer and an external information processing apparatus 400. In FIG. 10, a first multifunction printer 101a and a second multifunction printer 101b are identical in configuration to the multifunction printer 101 shown in FIG. 1. Moreover, the first multifunction printer 101a, the second multifunction printer 101b, and the external information processing apparatus 400 can communicate with one another through the Internet. Examples of the external information processing apparatus 400 include a Web server and a client PC.

Moreover, by changing the loop back address set in the URL to the address of the second multifunction printer 101b, the UI section 201 of the first multifunction printer 101a is allowed to notify the web server section 205 of the second multifunction printer 101b of a job execution instruction through the Internet and activate the content section 207 of the second multifunction printer 101b. On the other hand, by changing the loop back address set in the URL to the address of the first multifunction printer 101a, the UI section 201 of the second multifunction printer 101b is allowed to notify the web server section 205 of the first multifunction printer 101a of a job execution instruction through the Internet and activate the content section 207 of the first multifunction printer 101a.

Further, the information processing apparatus 400 may include a web browser section 202 and a web browser section 205. Moreover, by setting a URL containing as the address to be accessed the address of the first or second multifunction printer 101a or 101b and designating the content section 207 that is to be activated, the web browser section 202 of the information processing apparatus 400 is allowed to notify the web server section 205 of the information processing apparatus 400 of a job execution instruction through the Internet and activate the content section 207 of the first or second multifunction printer 101a or 101b.

Simply by thus changing the address contained in the URL to the address of the external first or second multifunction printer 101a or 101b, an operation can be realized in cooperation with an external multifunction printer. Moreover, in such an example as described above, communication between the first multifunction printer 101a, the second multifunction printer 101b, and the external information processing apparatus 400 is exclusively communication between the web browser sections 202 and the web server sections 205 according to the HTTP, and communication by control commands is not performed. Communication by control commands is performed exclusively between the content section 207 and the function disclosure section 208 within each multifunction printer 101. Therefore, even if there is such a firewall between one apparatus and another as to block communication by control commands, the functions of an external multifunction printer 101 can be easily controlled.

For example, in cases where the first multifunction printer 101a is busy with a job but its user would like to use the first multifunction printer 101a to execute a content section 207 located internally in the second multifunction printer 101b, the user needs only to use the first multifunction printer 101a to change the loop back call address contained in the URL to the global IP address (168.168.x.x) of the second multifunction printer 101b. This allows the web browser section 202 of the first multifunction printer 101a to call the second multifunction printer 101b by the URL (such as 168.168.x.x/scan/scanexe) and use the scan function, print function, etc. of the second multifunction printer 101b.

Similarly, a user who would like to use the second multifunction printer 101b or the information processing apparatus 400 to execute a content section 207 located internally in the first multifunction printer 101a needs only to use the second multifunction printer 101b or the information processing apparatus 400 to change the loop back call address contained in the URL to the global IP address (200.200.x.x) of the first multifunction printer 101a. This allows the web browser section 202 of the second multifunction printer 101a or of the information processing apparatus 400 to call the first multifunction printer 101a by the URL (such as 200.200.x.x/scan/scanexe) and use the scan function, print function, etc. of the first multifunction printer 101a.

The present invention is not limited to the description of the embodiments above, but may be altered by a skilled person within the scope of the claims. An embodiment based on a proper combination of technical means disclosed in different embodiments is encompassed in the technical scope of the present invention.

Finally, the blocks of the multifunction printer 101 may be realized by way of hardware or software as executed by a CPU as follows:

The multifunction printer 101 includes a CPU (central processing unit) and storage devices (recording media). The CPU (central processing unit) executes instructions in control programs realizing the functions. The memory devices include a ROM (read only memory) which contains programs, a RAM (random access memory) to which the programs are loaded, and a memory containing the programs and various data. The objective of the present invention can also be achieved by mounting to the multifunction printer 101 a computer-readable recording medium containing control program code (executable program, intermediate code program, or source program) for the printer drive section 6, which is software realizing the aforementioned functions, in order for the computer (or CPU, MPU) to retrieve and execute the program code contained in the recording medium.

The recording medium may be, for example, a tape, such as a magnetic tape or a cassette tape; a magnetic disk, such as a floppy (Registered Trademark) disk or a hard disk, or an optical disk, such as CD-ROM/MO/MD/DVD/CD-R; a card, such as an IC card (memory card) or an optical card; or a semiconductor memory, such as a mask ROM/EPROM/EEPROM/flash ROM.

The multifunction printer 101 may be arranged to be connectable to a communications network so that the program code may be delivered over the communications network. The communications network is not limited in any particular manner, and may be, for example, the Internet, an intranet, extranet, LAN, ISDN, VAN, CATV communications network, virtual dedicated network (virtual private network), telephone line network, mobile communications network, or satellite communications network. The transfer medium which makes up the communications network is not limited in any particular manner, and may be, for example, wired line, such as IEEE 1394, USB, electric power line, cable TV line, telephone line, or ADSL line; or wireless, such as infrared radiation (IrDA, remote control), Bluetooth (Registered Trademark), 802.11 wireless, HDR, mobile telephone network, satellite line, or terrestrial digital network.

As described above, a multifunction printer according to the present invention includes: display means; a web browser section that operates in accordance with a software for a web browser; a web server section that operates in accordance with a software for a web server; an application execution section that operates in accordance with at least one application which is executed on the web server; and a device control section for controlling a plurality of functions including a scan function, a print function, and an image data communication function, the web browser section performing a window display process for displaying in the display means an operation window indicated by window data obtained from the web server section and notifying the web server section of an application execution instruction being entered into the operation window, as soon as the web server section has received the application execution instruction, the application execution section executing an application corresponding to the application execution instruction and, in accordance with the application, sending the device control section a control command to control at least one of the plurality of functions, the device control section performing control based on the control command.

According to the foregoing configuration, the web browser section receives window data indicative of an operation window from the web server section within the same multifunction printer. Then, the web browser section notifies the web server section of an application execution instruction entered into the operation window, and the application execution section executes an application corresponding to the application execution instruction and, in accordance with the application, sends the device control section a control command to control the functions of the multifunction printer. This allows the device control section to control the various functions of the multifunction printer. For example, the device control section can execute the scan function, the print function, etc.

The web browser section here needs only to display in the display means the operation window indicated by the window data obtained from the web server section and notify the web server section of the application execution instruction. Therefore, the software for operating the web browser section can be realized by a general-purpose web browser, and it is not necessary to uniquely expand the general-purpose web browser. Further, even in the case of a version upgrade or change in the general-purpose web browser or web server, it is only necessary to make the version upgrade or change, and no other maintenance is needed.

Further, upon receiving an execution instruction to execute an application, the web server section causes the application execution section to execute the application. Such a process can be realized by software for general-purpose web servers. Therefore, the software for operating the web server section can be realized a general-purpose web server, and it is not necessary to uniquely expand the general-purpose web server. Further, even in the case of a version upgrade or change in the general-purpose web server or web server, it is only necessary to make the version upgrade or change, and no other maintenance is needed.

Further, the installation of a new application in the multifunction printer makes it possible to execute the new application by using the web browser section and the web server section. This application is executed on a web server. Moreover, as mentioned above, the web server section of each multifunction printer can use software for general-purpose web servers. This makes it only necessary to install the same application regardless of the model of each multifunction printer. This makes it possible, as a result, to easily add a function to each multifunction printer through an application.

This makes it possible to provide a multifunction printer to which a function can be easily added regardless of model.

Furthermore, the multifunction printer according to the present invention is preferably configured such that: the web browser section and the web server section communicate with each other according to HTTP; and the web browser section notifies the web server section of the application execution instruction by an HTTP request using a loop back address.

The foregoing configuration uses a general-purpose protocol, thereby making it possible to easily build a web browser section and a web server section.

Further, in cases where there occurs some sort of trouble (such as a paper jam) in the multifunction printer or a large number of jobs are being processed in the multifunction printer, by changing the loop back address to the address of an external multifunction printer, the external multifunction printer can be easily made to execute a job.

Furthermore, the multifunction printer according to the present invention is preferably configured such that in accordance with a URL containing the loop back address and application specifying information for specifying the application, the web browser section notifies the web server section of the application execution instruction.

This makes it possible to easily designate an application that is to be executed.

Furthermore, the multifunction printer according to the present invention is preferably configured to further include a storage section in which unique information indicative of performance of the multifunction printer is stored, wherein: as soon as the web server section has received from the web browser section a request to transmit the operation window, the application execution section obtains the unique information from the storage section and generates window data indicative of an operation window based on the unique information thus obtained; and the web server section sends the web browser section the window data generated by the application execution section, whereby the web browser section performs the window display process.

According to the foregoing configuration, the application execution section generates window data by obtaining unique information such as reading resolution. Therefore, an application for operating the application execution section can be designed for general purposes regardless of the model of multifunction printer. Furthermore, since the application execution section creates an operation window in accordance with the unique information, the multifunction printer can easily display an operation window according to its model.

Furthermore, the multifunction printer according to the present invention is preferably configured to further include an image reading section for reading an image from a document, wherein: the web browser section displays the operation window in the display means and notifies the web server section of the application execution instruction, the operation window being a scan start operation window for receiving a start instruction for the image reading section to start a reading operation, the application execution instruction being the start instruction for the image reading section to start the reading operation; as soon as the web server section has received the start instruction for starting the reading operation, the application execution section sends the device control section a control command for the image reading section to start the reading operation. This allows the multifunction printer to execute a scan.

Furthermore, the multifunction printer according to the present invention is preferably configured to further include: an image reading section for reading an image from a document; and an image forming section for printing on a sheet of paper an image indicated by input image data, wherein: the web browser section displays the operation window in the display section, the operation window being an authentication information entry window that prompts a user to enter authentication information for user authentication; furthermore, upon entry of authentication information into the authentication information entry window, the web browser section sends the application execution instruction to the web server section, the application execution instruction being a restriction instruction to restrict a function of at least either the image reading section or the image forming section, the restriction instruction corresponding to a user indicated by the authentication information; and as soon as the web server section has received the restriction instruction, the application execution section specifies, from prestored correspondence information that associates each piece of authentication information with a piece of restriction information indicative of a restriction method for restricting the function of at least either the image reading section or the image forming section, restriction information corresponding to the authentication information of the restriction instruction, and sends the device control section a control command to restrict the function of at least either the image reading section or the image forming section in accordance with a restriction method indicated by the restriction information.

The foregoing configuration makes it possible, for example, to prohibit color copying and/or restrict the number of copies to 100 according to users.

Furthermore, the multifunction printer according to the present invention is preferably configured to further include an image forming section for printing on a sheet of paper an image indicated by input image data, wherein: the web browser section displays the operation window in the display means, the operation window being an image data selection window for specifying image data to be printed; furthermore, upon entry in the image data selection window of specifying information for specifying image data, the web browser section sends the application execution instruction to the web server section, the application execution instruction being an print instruction to print an image indicated by specific image data indicated by the specifying information; and as soon as the web browser section has received the print instruction, the application execution section obtains the specific image data and sends the device control section a control command to print the image indicated by the specific image data.

According to the foregoing configuration, storage of print data in advance in a predetermined folder makes it possible to obtain, from a plurality of multifunction printers, recording sheets on each of which the image indicated by the specific image data has been printed.

Furthermore, the multifunction printer according to the present invention is preferably configured such that the application is written in Java (Registered Trademark) Script.

The foregoing configuration makes it possible to create an application in a general-purpose language, thereby making it easy to develop an application.

The multifunction printer may be realized by a computer. In this case, a program for realizing a multifunction printer by computer by causing a computer to function as each of the sections and a computer-readable recording medium containing such a program are also encompassed in the scope of the present invention.

### INDUSTRIAL APPLICABILITY

The present invention can be applied to a multifunction printer that fulfils a plurality of functions such as copying, scanning, and FAX.

### REFERENCE SIGNS LIST

101 Multifunction printer
101a First multifunction printer
101b Second multifunction printer
102 Communication network
103 File server
201 UI section
202 Web browser section
203 Operation section (display means)
204 Embedded server section
205 Web server section
206 Content management section
207 Content section (application execution section)
208 Function disclosure section (storage section)
209 Device control section
210 Image forming section
211 Network scanner section
212 Image reading section
213 Data conversion section
214 Data communication section
215 Communication control section

1. A multifunction printer comprising:
display means;
a web browser section that operates in accordance with a software for a web browser;
a web server section that operates in accordance with a software for a web server;
an application execution section that operates in accordance with at least one application which is executed on the web server; and
a device control section for controlling a plurality of functions including a scan function, a print function, and an image data communication function,
the web browser section performing a window display process for displaying in the display means an operation window indicated by window data obtained from the web server section and notifying the web server section of an application execution instruction entered into the operation window,
as soon as the web server section has received the application execution instruction, the application execution section executing an application corresponding to the application execution instruction and, in accordance with the application, sending the device control section a control command to control at least one of the plurality of functions,
the device control section performing control based on the control command.

2. The multifunction printer as set forth in claim 1, wherein:
the web browser section and the web server section communicate with each other according to an HTTP; and
the web browser section notifies the web server section of the application execution instruction by an HTTP request using a loop back address.

3. The multifunction printer as set forth in claim 2, wherein in accordance with a URL containing the loop back address and application specifying information for specifying the application, the web browser section notifies the web server section of the application execution instruction.

4. The multifunction printer as set forth in claim 1, further comprising a storage section in which unique information indicative of performance of the multifunction printer is stored, wherein:
as soon as the web server section has received from the web browser section a request to transmit the operation window, the application execution section obtains the unique information from the storage section and generates window data indicative of an operation window based on the unique information thus obtained; and
the web server section sends the web browser section the window data generated by the application execution section, whereby the web browser section performs the window display process.

5. The multifunction printer as set forth in claim 1, further comprising an image reading section for reading an image from a document, wherein:
the web browser section displays the operation window in the display means and notifies the web server section of the application execution instruction, the operation window being a scan start operation window for receiving a start instruction for the image reading section to start a reading operation, the application execution instruction being the start instruction for the image reading section to start the reading operation;
as soon as the web server section has received the start instruction for starting the reading operation, the application execution section sends the device control section a control command for the image reading section to start the reading operation.

6. The multifunction printer as set forth in claim 1, further comprising:
an image reading section for reading an image from a document; and
an image forming section for printing on a sheet of paper an image indicated by input image data, wherein:
the web browser section displays the operation window in the display section, the operation window being an authentication information entry window that prompts a user to enter authentication information for user authentication;
furthermore, upon entry of authentication information into the authentication information entry window, the web browser section sends the application execution instruction to the web server section, the application execution instruction being a restriction instruction to restrict a function of at least either the image reading section or the image forming section, the restriction instruction corresponding to a user indicated by the authentication information; and
as soon as the web server section has received the restriction instruction, the application execution section specifies, from prestored correspondence information that associates each piece of authentication information with a piece of restriction information indicative of a restriction method for restricting the function of at least either the image reading section or the image forming section, restriction information corresponding to the authentication information of the restriction instruction, and sends the device control section a control command to restrict the function of at least either the image reading section or the image forming section in accordance with a restriction method indicated by the restriction information.

7. The multifunction printer as set forth in claim 1, further comprising an image forming section for printing on a sheet of paper an image indicated by input image data, wherein:
the web browser section displays the operation window in the display means, the operation window being an image data selection window for specifying image data to be printed;
furthermore, upon entry in the image data selection window of specifying information for specifying image data, the web browser section sends the application execution instruction to the web server section, the application execution instruction being an print instruction to print an image indicated by specific image data indicated by the specifying information; and
as soon as the web browser section has received the print instruction, the application execution section obtains the specific image data and sends the device control section a control command to print the image indicated by the specific image data.

8. The multifunction printer as set forth in claim 1, wherein the application is written in Java (Registered Trademark) Script.

9. A computer-readable recording medium containing a program for causing a computer to function as each of the sections included by a multifunction printer as set forth in claim 1.
